(19) United States
(12) Patent Application Publication
(10) Pub. No.: US 2012/0251988 A1
(43) Pub. Date: Oct. 4, 2012

(54) REWARD DISPENSER

(76) Inventor: Joshua Thomas Moffatt, Littleton, CO (US)

(21) Appl. No.: 13/418,074

(22) Filed: Mar. 12, 2012

Related U.S. Application Data
(60) Provisional application No. 61/516,276, filed on Apr. 1, 2011.

(51) Int. Cl. G09B 19/00

(52) U.S. Cl. 434/236

(57) ABSTRACT

A reward dispenser is disclosed. An example reward dispenser includes a trap door to keep a reward from falling out of a dispenser compartment. The reward dispenser also includes a release mechanism to open the trap door so that all reward in the dispenser compartment falls outside of the reward dispenser. The reward dispenser also includes a closing mechanism to automatically close the trap door after the reward falls out of the reward dispenser, so that another reward can be loaded into the dispenser compartment.

### PRIORITY CLAIM

This application claims priority to U.S. Provisional Patent Application No. 61/516,276 titled “Toilet Training Reward Dispenser (Poop n. Pull)” of Joshua Thomas Moffatt, filed Apr. 1, 2011, hereby incorporated herein by reference as though fully set forth herein.

### BACKGROUND

It has been shown that good behavior can be learned and reinforced by offering a reward immediately following the good behavior. This is particularly true of small children learning to use the toilet so that they no longer need to wear diapers, and may also be referred to as “potty training.”

However, parents can be inconsistent when implementing reward systems. For example, a parent potty training their child may offer the child candy when the child uses the toilet one time, and another time may simply say to the child that they will go out to the park that afternoon, and another time may forget altogether to offer a reward.

### BRIEF DESCRIPTION OF THE DRAWINGS

FIG. 1 is a perspective view of an example reward dispenser.

FIG. 2 is a side view of the example reward dispenser shown in FIG. 1.

FIG. 3 is a cut-away front view of the example reward dispenser shown in FIG. 1, illustrating a reward dispensing mechanism for treats stored inside.

FIG. 4 is the cut-away front view of the example reward dispenser shown in FIG. 1, illustrating operation of the reward dispensing mechanism.

FIG. 5 is a cut-away side view of the example reward dispenser shown in FIG. 1, also illustrating operation of the reward dispensing mechanism.

### DETAILED DESCRIPTION

Inconsistency in implementing a reward system for teaching a desired behavior, such as but not limited to toilet training a small child, may confuse the child and delay the child learning the desired behavior. It has been shown that good behavior can be learned and reinforced by offering a reward immediately following the good behavior. This is particularly true of small children learning to use the toilet, but also teaching children (and even pets) desired behavior.

A reward dispenser is disclosed which promotes consistency during training exercises. An example reward dispenser includes a trap door to keep a reward from falling out of a dispenser compartment. The reward dispenser also includes a release mechanism to open the trap door so that all reward in the dispenser compartment falls outside of the reward dispenser. The reward dispenser also includes a closing mechanism to automatically close the trap door after the reward falls out of the reward dispenser, so that another reward can be loaded into the dispenser compartment.

Before continuing, it is noted that as used herein, the terms “includes” and “including” mean, but is not limited to, “includes” or “including” and “includes at least” or “including at least.” The term “based on” means “based on” and “based at least in part on.”

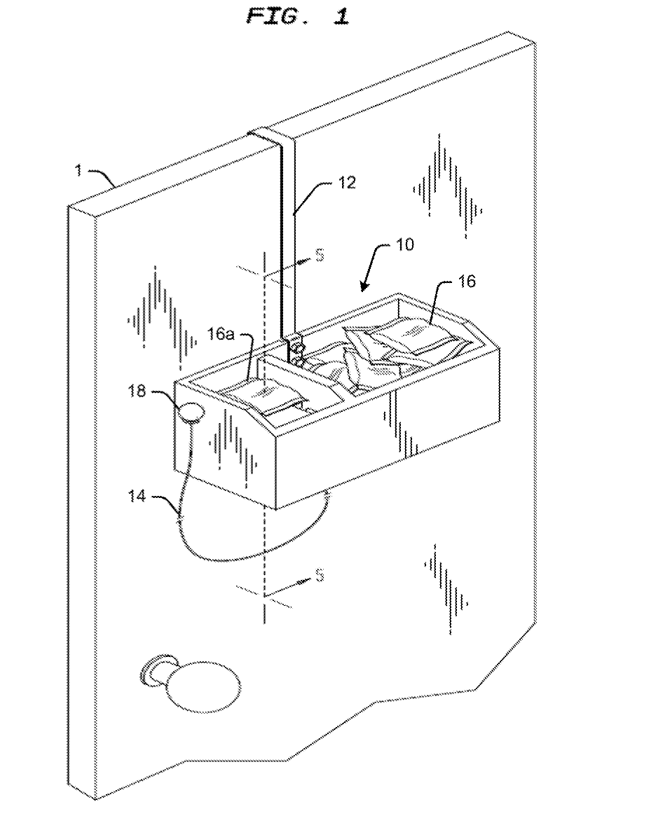

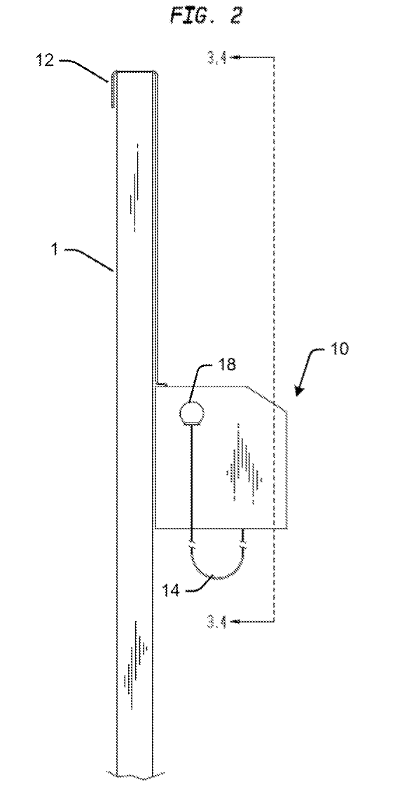

FIG. 1 is a perspective view of an example reward dispenser 10. FIG. 2 is a side view of the example reward dispenser 10 shown in FIG. 1. In this example, the reward dispenser 10 is shown as it may be hung on a door 1 using hanger 12. Accordingly, the reward dispenser 10 may be hung at a height such that a small child cannot simply reach in and take out the rewards 16. Also in this regard, a cord 14 that may be used by the child with the parent's permission to release a reward 16a from the reward dispenser 10 may be hung up on retainer hook 18 out of reach of the child so that the child cannot simply pull the cord 14 at will to release the reward 16a. Instead, the parent may first remove the cord 14 from the retainer hook 18, thus extending the cord 14 down within reach of the child so that the child can release the reward 16a at the appropriate time (e.g., in response to having properly used the toilet during potty training).

As will be apparent to one having ordinary skill in the art after becoming familiar with the teachings herein, the reward dispenser provides a simple and convenient way to consistently reward children for successful potty training. The reward dispenser can readily be hung on the door of a bathroom or in another desired location, so that it is available for immediate and easy access after the child has successfully used the toilet. The reward dispenser provides a fun way for a child to get excited about toilet training, by involving the child in the reward process (e.g., by allowing the child to pull the cord and dispense the reward).

The reward dispenser also includes a storage compartment so that additional rewards can be readily stored and accessed, providing a more consistent reward system. The rewards 16 may be any suitable treat, such as candy, small toys, etc.

Although illustrated herein with regard to use in potty training, however, it is noted that the reward dispenser may be used to teach a child any desired behavior. Indeed, the reward dispenser may even be used to train pets, such as dogs.

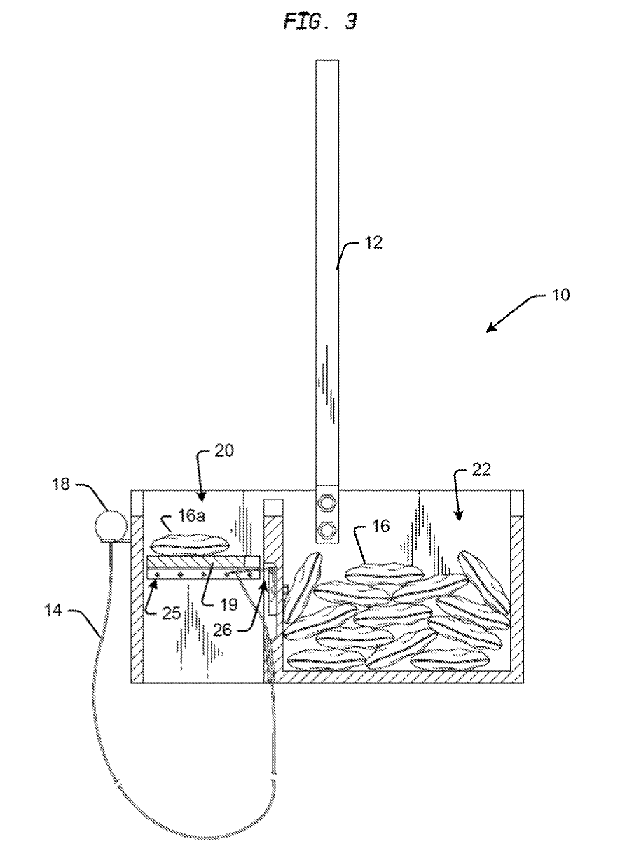

FIG. 3 is a cut-away front view of the example reward dispenser 10 shown in FIG. 1, illustrating a reward dispensing mechanism for treats stored inside. The cut-away side view is taken along lines 3-3 in FIG. 2. In FIG. 3, a trap door 19 is shown in a closed or “ready” position, wherein the reward 16a is sitting on top of the trap door 19 in a dispenser compartment 20. Additional rewards 16 are in a separate storage compartment 22. The cord 14 is shown hanging out of reach of a small child on hook 18.

It is noted that the parent may choose not to transfer the reward 16a from the storage compartment 22 to the dispenser compartment 20 until the reward dispenser 10 is going to be used, such as when the child enters the bathroom to use the toilet. This preventative measure may be implemented in addition to or instead of hanging the cord 14 out of reach of the child.

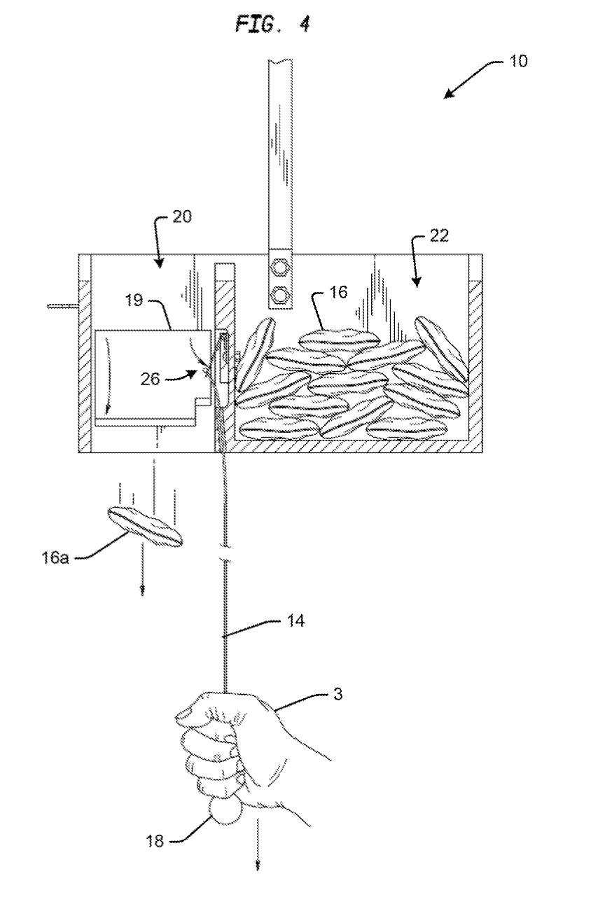

FIG. 4 is the cut-away front view of the example reward dispenser 10 shown in FIG. 1, illustrating operation of the reward dispensing mechanism. The cut-away side view is taken along lines 4-4 in FIG. 2. FIG. 4 illustrates a child's hand 3 pulling on the cord 14 to open the trap door 19 so that the reward 16a drops immediately out of the reward dispenser 10 and is available for the child without having to wait.

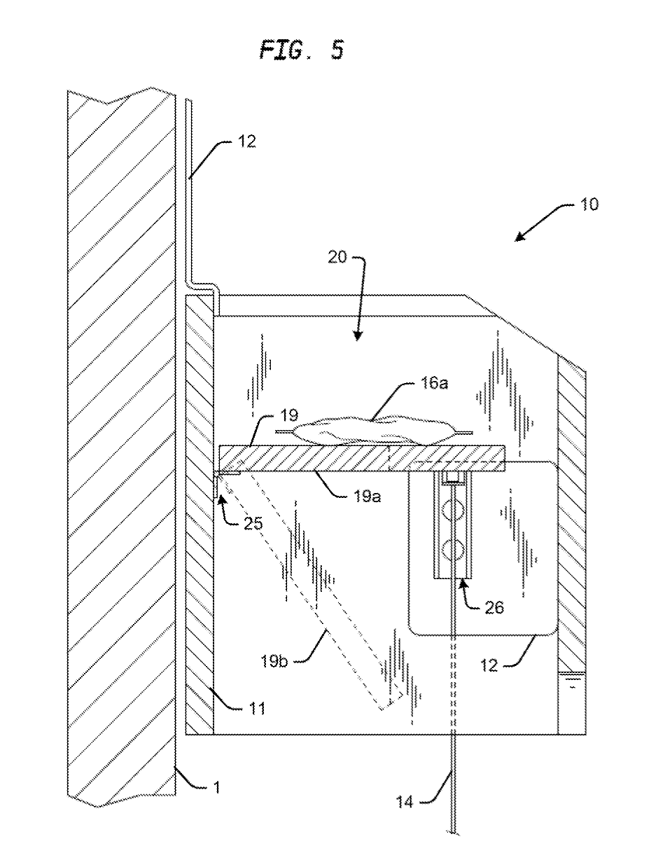

FIG. 5 is a cut-away side view of the example reward dispenser 10 shown in FIG. 1, also illustrating operation of the reward dispensing mechanism. The cut-away side view is taken along lines 5-5 in FIG. 1. FIG. 5 illustrates the trap door 19 in both a closed position (shown by solid lines 19a) and an open position (shown by dashed lines 19b).

The trap door 19 is attached to a back surface 11 of the reward dispenser 10 by a hinge 25. The hinge allows the trap door to pivot between the closed position illustrated by the solid lines 19a to hold the reward 16a in the dispensing compartment 20, and the open position illustrated by the dashed lines 19b to release the reward 16a.

The trap door 19 is normally retained in the closed position by a mechanism. In an example, the mechanism may include a spring-loaded latch 26 that can be mounted to a side surface 12 of the reward dispenser 10. The spring biases hinged legs of the latch 26 at substantially 90 degree to one another. For example, the spring may be provided around the hinge pin between the legs of latch 26, with opposite ends of the spring pressing in opposite directions against the legs. As such, the latch 26 normally holds the trap door 19 upright in the closed position.

When the cord 14 is pulled against the force of the spring, the two legs of latch 26 pinch together, moving out of the way of the trap door 19 so that the trap door 19 falls open under the force of gravity and the reward 16a drops out of the reward dispenser 10.

In an example, the parent may pull the cord 14 and raise the trap door 19 after the reward 16a has been released by pushing the trap door 19 back into the closed position 19a, and then releasing the cord 14 so that the spring bias again holds the trap door 19 in the closed position 19a.

In another example, the hinge 25 may also be spring-biased to automatically return the trap door 19 to the closed position 19a.

Before continuing, it should be noted that the examples described above are provided for purposes of illustration, and are not intended to be limiting. Other devices and/or device configurations may be utilized to carry out the operations described herein. For example, the separate functions of the hinge and mechanism 24 may be combined into a single spring-biased hinge such that separate components are not used to achieve the same result.

By way of further example, the reward dispenser may include a sloped floor in the storage compartment, so that additional rewards move automatically by sliding into the dispenser compartment. The reward dispenser may also include a lid. One or more lock may also be provided (e.g., on the lid and/or the pull cord), such that a parent may lock the reward dispenser and keep the child from obtaining rewards without prior permission from the parent.

Still further examples may include prerecorded music and/or congratulatory messages and/or lighting may be activated when the cord is pulled (or to alert the parent that the rewards have been or soon will be depleted. For example, a sensor such as a weight sensor may detect when the storage compartment is empty or approaching empty. Likewise, an alert buzzer and/or red light may be activated when the cord is pulled without permission. For example, the parent may need to press a bypass button before the cord is pulled to deactivate the alert system during permissible use. If the cord is pulled without first bypassing the alert system, then the alert system may be triggered to prevent unauthorized use of the reward system by the child.

A method of providing a reward for behavior training. The method may include holding the reward in a dispenser compartment, opening a trap door under the dispenser compartment in response to a user action to release the reward from the dispenser compartment, and automatically closing the trap door to load another reward in the dispenser compartment.

The operations shown and described herein are provided to illustrate example implementations. It is noted that the operations are not limited to the ordering shown. Still other operations may also be implemented with the reward dispenser disclosed herein.

Example operations may further include holding multiple rewards in a storage compartment separate from the dispenser compartment. Other operations may also include transferring the rewards from the storage compartment to the dispenser compartment. Other operations may include transferring the rewards from the storage compartment to the dispenser compartment is only after automatically closing the trap door. In an example, transferring the rewards is one at a time from the storage compartment to the dispenser compartment so that only one reward is in the dispenser compartment at the same time.

It is noted that the examples shown and described are provided for purposes of illustration and are not intended to be limiting. Still other examples are also contemplated.

1. A method of providing a reward for behavior training, comprising:
holding the reward in a dispenser compartment;
opening a trap door under the dispenser compartment in response to a user action to release the reward from the dispenser compartment; and
automatically closing the trap door to load another reward in the dispenser compartment.

2. The method of claim 1, further comprising holding multiple rewards in a storage compartment separate from the dispenser compartment.

3. The method of claim 2, further comprising transferring the rewards from the storage compartment to the dispenser compartment.

4. The method of claim 3, wherein transferring the rewards from the storage compartment to the dispenser compartment is only after automatically closing the trap door.

5. The method of claim 3, wherein transferring the rewards is one at a time from the storage compartment to the dispenser compartment so that only one reward is in the dispenser compartment at the same time.

6. A reward dispenser, comprising:
a trap door to keep a reward from falling out of a dispenser compartment;
a release mechanism to open the trap door so that all reward in the dispenser compartment falls outside of the reward dispenser; and
a closing mechanism to automatically close the trap door after the reward falls out of the reward dispenser, so that another reward can be loaded into the dispenser compartment.

7. The reward dispenser of claim 6, wherein the release mechanism includes a pull cord.

8. The reward dispenser of claim 7, wherein the pull cord is storable on a cord hanger out of reach of a small child, and wherein the pull cord is movable to be within reach of the small child.

9. The reward dispenser of claim 6, wherein the closing mechanism is a spring-loaded trigger.

10. The reward dispenser of claim 6, further comprising an over-the-door hanger.

11. The reward dispenser of claim 6, further comprising a storage compartment separate from the dispenser compartment.

12. The reward dispenser of claim 11, wherein rewards are transferred from the storage compartment to the dispenser compartment before being released through the trap door.

13. The reward dispenser of claim 12, wherein the rewards are transferred from the storage compartment to the dispenser compartment only after the trap door is closed.

14. The reward dispenser of claim 12, wherein the dispenser compartment is configured to hold only one reward at a time.

15. The reward dispenser of claim 12, further comprising an alert system to prevent unauthorized use of the reward dispenser.

16. A reward dispenser for behavior training, comprising:
means for holding a reward until the reward is earned;
means for opening a trap door in response to a user action to release all of the reward from the means for holding the reward, the reward falling outside of the reward dispenser; and
means for automatically closing the trap door for reloading the means for holding the reward with a next reward.

17. The reward dispenser of claim 16, wherein the means for opening the door immediately releases the reward outside of the reward dispenser.

18. The reward dispenser of claim 16, wherein the means for opening the door includes at least a pull cord.

19. The reward dispenser of claim 16, wherein means for automatically closing the door includes at least a spring-loaded trigger.

20. The reward dispenser of claim 16, further comprising means for hanging the reward out of reach of a small child.
